(19) United States
(12) Patent Application Publication
(10) Pub. No.: US 2026/0238237 A1
(43) Pub. Date: Aug. 13, 2026

(54) DIFFERENTIATED ULTRA-WIDEBAND SENSING ARCHITECTURE

(71) Applicant: Infineon Technologies AG, Neubiberg (DE)

(72) Inventors: Ajinder Pal Singh, Allen, TX (US); Daniel Lee, Salt Lake City, UT (US); Cecilia Carbonelli, München (DE)

(21) Appl. No.: 19/047,847

(22) Filed: Feb. 7, 2025

(51) Int. Cl. H04B 1/00

(52) U.S. Cl. CPC H04B 1/0092; H04B 1/0032

(57) ABSTRACT

Systems, methods, and circuitries are provided for detecting vital signs based on ultra-wideband (UWB) signals. In one example, a method incudes processing received UWB signals to generate first digital profile data; detecting at least one peak in the first digital profile data; generating a de-spreading template based on the at least one peak; de-spreading the received UWB signal based on the de-spreading template; generating second digital profile data based on the de-spread received UWB signal; and detecting vital signs based on the second digital profile data.

### FIELD

The present disclosure relates generally to the field of processors and in particular to processors for ultra-wideband (UWB) signals

### BACKGROUND

Ultra-wideband signals are well suited for secure ranging techniques because these signals enable accurate distance measurement between devices.

### BRIEF DESCRIPTION OF THE DRAWINGS

Some examples of circuits, apparatuses and/or methods will be described in the following by way of example only. In this context, reference will be made to the accompanying Figures.

FIG. 1 illustrates an example automotive UWB system.

FIG. 2 illustrates an example ultra-wideband (UWB) symbol.

FIG. 3 shows a simplified illustration of an example round of several cycles of frame transmission and receipt for establishing a channel impulse response (CIR) profile by the UWB system of FIG. 2.

FIG. 4 illustrates an example CIR profile for the UWB system of FIG. 2.

FIG. 5 illustrates an example UWB receiver, in accordance with various aspects described.

FIG. 6 illustrates an example UWB receiver, in accordance with various aspects described.

FIG. 7 illustrates a low noise amplifier (LNA) muting signal, in accordance with various aspects described.

FIG. 8 illustrates an example analog-to-digital converter, in accordance with various aspects described.

FIG. 9 is flow diagram outlining an example method for detecting vital signs based on UWB signals, in accordance with various aspects described.

### DETAILED DESCRIPTION

The present disclosure is described with reference to the attached figures. Similar components in various figures may be represented by similar reference characters. The figures are not drawn to scale and they are provided merely to illustrate the disclosure. Several aspects of the disclosure are described below with reference to example applications for illustration. Numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the selected present disclosure.

Impulse-Radio Ultra-Wide-Band (IR-UWB) refers to a low-power wireless near-field communication technology that uses numerous very short and narrow radio-frequency electromagnetic pulses transmitted over a wide frequency band. Typically, the transmitted pulses are shorter than 2 ns, the transmit power is limited to −41.3 dBm/MHz, and the corresponding bandwidth is in the neighborhood of 500 MHz or more. In addition to being useful for communication and sensing, the shortness and narrowness of the transmitted pulses also allow for an accurate calculation of distances between transceivers by, for example, using two-way ranging.

Two way ranging involves calculating a time-of-flight (ToF) for transmitted messages based on tracking message receipt, transmission, and processing times for the two transceivers. One of the two transceivers may be designated as an anchor and the other may be designated as a tag. Generally, the more-fixed transceiver would be designated as the anchor. However, the designations may be dynamic such that, for example, where both transceivers are implemented in mobile devices, the anchor and tag designations may alternate between the two transceivers during the two-way ranging procedure. The distance between a tag and an anchor may be determined by multiplying the calculated time of flight (typically lasting no more than a few nanoseconds) by the speed of light.

Some automotive UWB systems utilize multiple UWB anchor transceivers (a.k.a. anchors) located in respective fixed locations in an automobile to calculate respective distances to a UWB tag such as a key fob. The UWB system can use the calculated distance information to determine the location of the key fob, using, e.g., trilateration, which refers to localization based on calculating an intersection of circles centered on respective anchors. The UWB system may then provide corresponding automotive functionality based on the determined location of the tag—e.g., locking and/or unlocking the driver door or trunk or enabling and/or disabling a motor start. Typically, prior to the provision of automotive functionality, the key fob is first securely verified using an authentication protocol. The authentication protocol may use one or more UWB anchors or may instead, or in addition, use other wireless communication technologies such as, for example, Bluetooth (a registered trademark of Bluetooth SIG, Inc.).

UWB signals may also be used to detect objects within the passenger compartment of a vehicle. As will be discussed below, in these applications UWB signals are used to sense channels within the passenger compartment to detect the presence of objects.

### UWB Based Object Detection Overview

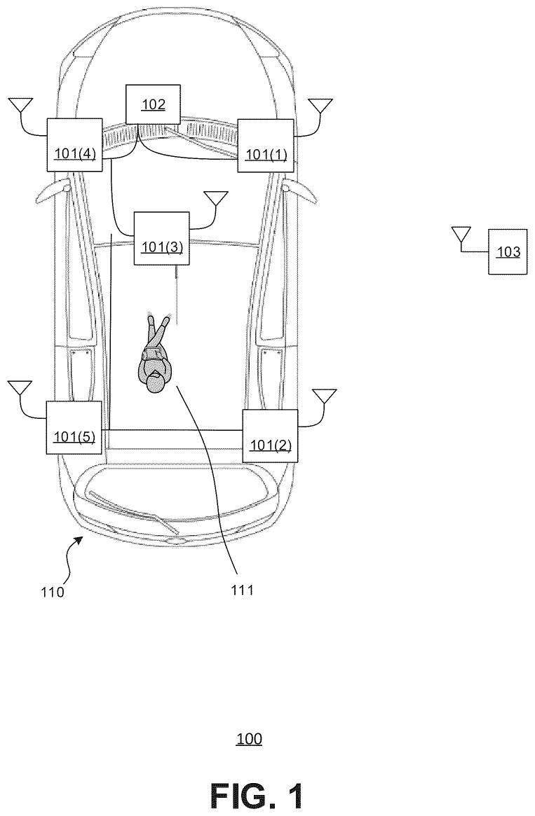

FIG. 1 illustrates an example automotive UWB system 100 that includes a UWB tag transceiver 103 and an automobile 110 that includes a plurality of UWB anchor transceivers 101, namely anchors 101(1)-101(5), which are communicatively connected to a controller 102. The controller 102 may, for example, be circuitry implemented in an engine control unit (ECU) integrated circuit and may include a digital signal processor (DSP) as well as an artificial-intelligence (AI) accelerator or other suitable module for running machine-learning models. If the tag 103 is within range of the automobile 110, then a set of the plurality of UWB anchors 101—e.g., anchors 101(1), 101(2), and 101(3)—may be used by the controller 102 to determine the location of the tag 103 by, for example, trilateration, which may involve calculating the respective distances from the tag 103 to each of the anchors 101 in the set and then determining an intersection of correspondingly sized circles around each of the anchors 101 of the set. Notably, this implementation does not require synchronizing clocks among the anchors 101 as the distance from the tag 103 to each anchor 101 of the set is independently determined by the respective anchor 101.

Each anchor 101 comprises one or more antennas for transmitting and/or receiving signals, wherein each antenna may be located inside or outside the cabin of automobile 110. An anchor 101 may also comprise a set of antennas where some are inside the cabin and some are outside. For example, anchors 101 located at or near the body shell of the automobile 110, such as anchors 101(1), 101(2), 101(4), and 101(5), may comprise at least a first antenna located inside the cabin, for cabin communication and/or sensing, and a second antenna located outside the cabin, for external communication and/or sensing. The controller 102 can select particular subsets of interior and/or exterior antennas of the set of anchors 101 for particular corresponding communication or sensing operations.

Each anchor 101 and/or the controller 102 may include a packaged integrated circuit (IC) including semiconductor devices arranged on a semiconductor substrate, such as, for example, a silicon substrate, germanium arsenide substrate, or other suitable semiconductor substrate. In some cases, each anchor 101 may include multiple ICs that are stacked and/or packaged in a so-called three-dimensional IC (3D-IC), or which can be coupled to one another via conductive traces on a printed circuit board. The anchors 101 and/or controller 102 can be coupled to one another via copper wires, coaxial cables, optical cables, and/or wireline cabling, and/or can be coupled wirelessly to one another.

The UWB system 100 may attempt to determine the location of the tag 103 periodically at some preset time intervals, intermittently based on some automatic calculation, in response to particular triggers, or on any other suitable basis. Multiple distance determination can be used to determine motion of the tag 103. As the determined location of the tag 103 changes, the controller 102 can take corresponding actions.

Significantly, UWB transceiver systems are also capable of detecting non-transmitting targets in their vicinity. This is accomplished by analyzing changes in received signals that result from the introduction of a non-transmitting target into the transmission environment and the interaction of the non-transmitting target with the transmitted signal from transmitter to receiver—specifically, by altering the channel impulse response (CIR) characteristics for the transmission. For example, introducing an object that reflects and/or absorbs a transmission signal into the transmission environment of the transmitter and receiver results in the arrival of multiple copies (at varying strengths) of the signal at the receiver at delays that may be discernable (e.g., from line-of-sight transmissions, other reflections, and/or ambient noise) and that can be used to calculate a distance to the reflecting object and/or determine additional information about the object, such as physical characteristics of the object.

Humans make up one type of detection target of particular interest in automotive and other applications. While it may be presumed, in many contexts, that movement of a transmitting tag, such as a key fob, close to and inside a vehicle is indicative of a human user using it, it would also be useful to be able to detect non-transmitting human targets such as adults and/or children who are not carrying a transmitting tag. FIG. 1 includes a person 111 in the back seat, who may be, for example, a child or other non-transmitting target of interest. The controller 102 is configured to execute a human-detection process, in conjunction with the anchors 101, to detect a presence of the person 111.

If the controller 102 determines that a human is present without the driver in a parked vehicle, then the controller 102 can take one or more alert actions. The controller 102 may send a notification alert to the driver using a cellular, or other wireless, network. The controller 102 may send a notification alert to first responders providing notification of a child alone in a vehicle. The controller 102 may also trigger other alert actions, such as, for example, flashing the headlines or honking the horn of the automobile 110.

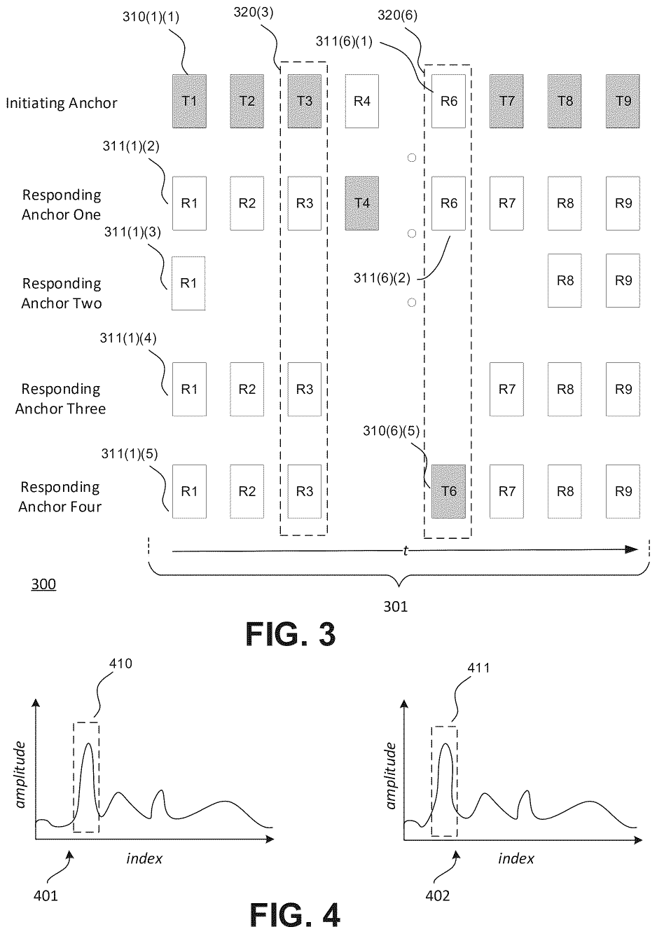

In some examples, a single anchor 101 may be used to transmit the UWB signal and receive reflected versions of the transmitted signal. This technique, which includes a single transmitter/receiver device is called mono-static sensing. Using a set of three or more anchors 101 in order to detect a person 111 may be referred to as multi-static sensing, as distinguished from bi-static sensing, which uses two anchors. An example multi-static sensing process is illustrated in FIG. 3. Since the relative locations of the anchors 101 are fixed, establishing the baseline CIR profile provides useful phase and signal information and, furthermore, plural sets of the anchors 101 may be operated as phased arrays. The controller 102 may analyze the received raw data directly or may process it to obtain and analyze, for example, range, frequency, and/or phase information. The obtaining and analysis of the data may be performed using predetermined algorithms, dynamic algorithms, and/or machine-learning models.

### UWB Signal Overview

IEEE 802.15.4z standardizes two modes of ranging operation: Low-Rate Pulse (LRP) and High-Rate Pulse (HRP). Packet formats, implementation, and security of LRP and HRP differ. To limit interference, regulators restrict the output power of UWB receivers in proportion to their communication rate. Under these regulations, as the pulse rate increases, the maximum allowed transmission power per pulse should decrease. LRP pulses may therefore be transmitted at a higher power than HRP pulses, and in many scenarios individual LRP type pulses can be detected and decoded by the receiver.

In contrast, due to the lower transmission power of an HRP type pulse, in many application scenarios individual HRP type pulses may not be detectable by the receiver. HRP mode thus requires that the energy is split up into many pulses to transmit information successfully. The security concept of HRP reflects the fact that HRP type pulses are low power and to enhance security, HRP type pulses encode what is referred to as a random secure training sequence, a scrambled time sequence, or a scrambled timestamp sequence (referred to interchangeably as STS). The STS may be up to 4096 HRP pulses long. The receiver detects the STS through autocorrelation with a stored reference STS template. Typically, one of the correlation peaks is used to determine the time of arrival of the packet. Contrary to LRP where the polarity of each pulse is detected, HRP receivers determine the time of arrival (ToA) of a transmitted UWB STS signal based on an aggregation of received pulses.

The HRP UWB Enhanced ranging device (ERDEV) communication protocol specifies UWB communication based on physical layer (PHY) protocol data unit (PPDU) frames. Each PPDU frame may include a synchronization header (SHR), a physical layer header (PHR), physical layer service data unit (PSDU) carrying the data payload, and the STS. The PHR conveys information used by the receiver for decoding the payload such as, for example, data rate, frame length, preamble length, and a Hamming block code that enables correction of a single error and detection of two errors (SECDED) in the decoded signal. The PSDU is the PHY payload. The payload, may include, for example, location data, sensor data, control commands, device status, device identification, and so on, depending on the use case and application.

In the UWB signal, the PHR and PSDU bits may be separately encoded using SECDED encoding for the PHR bits and Reed-Solomon encoding for the PSDU bits. The encoded PHR and PSDU bits are subject to further convolutional encoding. The resulting bits are modulated using burst position modulation (BPM)-binary phase shift keying (BPSK) modulation into a symbol.

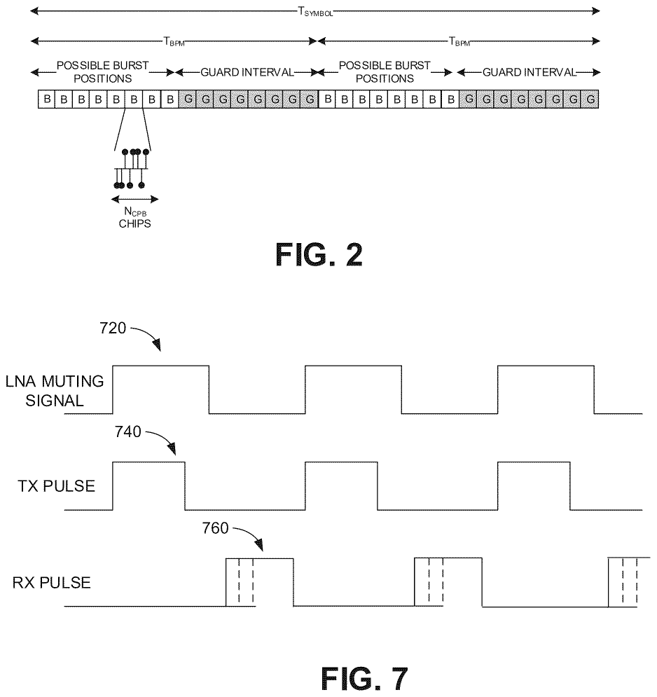

An example BPM-BPSK symbol is illustrated in FIG. 2. The symbol is divided into two BPM intervals (T_{BPM}). Each BPM interval is divided into two halves. A BPM interval includes several burst positions, designated B in FIG. 2, in the first half of each BPM interval with the second half of each BPM interval serving as a guard interval (indicated by positions labeled G) during which bursts are not permitted. The BPM interval in which the burst is located encodes either a 0 or 1. For example, in some BPM modulation schemes when the burst is in the first BPM interval, the encoded value corresponds to a 0 and when the burst is in the second BPM interval, the encoded value corresponds to a 1.

As discussed above, to communicate a bit of information, a symbol is repeated a number of times in the UWB signal and the receiving device accumulates the repeated symbols to obtain sufficient energy for decoding the bit value. In some examples, the UWB signal repeats each symbol 512 times. Each symbol includes a burst located at a particular (time) position in the symbol. A burst is a series of impulses of either 1 or −1. The number of impulses or “chips” in a burst (N_{CPB}) is defined by a chip rate for the modulation scheme. N_{CPB} is 8 in the symbol illustrated in FIG. 2. The polarity of the chips may be chosen in such a way that the spectrum of the transmitted waveform is smoothed. The use of multiple chips to encode a single bit value spreads the UWB signal and provides interference suppression.

In each symbol, the burst is transmitted in only one of the burst positions. The burst position for a given transmitter can vary on a symbol-to-symbol basis following a time hopping code. The use of a time hopping code provides resistance to multi-user interference in cases where all users have their own time hopping code.

FIG. 3 shows a simplified illustration 300 of an example round 301 of several cycles 320 of frame transmission and receipt for establishing a CIR profile by, for example, the UWB system 100 of FIG. 1. The profile-establishing round 301 starts with an initiating anchor 101 (e.g., anchor 101(1)) transmitting a first set of signals (e.g., a PPDU frame) 110(1)(1), where the parentheticals in the label indicate the cycle number and the anchor number, and also shown as T1 in the illustration. The first set of signals 310(1)(1) is then received by a set of responding anchors 101 (e.g., anchors 101(2), 101(3), 101(4), and 101(5)) as received sets of signals 311 (e.g., received frames 311(1)(2), 311(1)(3), 311(1)(4), and 311(1)(5), respectively, where the parentheticals in the label similarly indicate the cycle number and the anchor number), also shown as R1. As noted above, to facilitate understanding of the illustration, transmission frames 310 are labeled with a T prefix and an ordinal suffix and are shaded (e.g., T1, T2, etc.), while received frames 311 are labeled with an R prefix and an ordinal suffix (e.g., R1, R2, etc.).

One or more subsequent cycles 320, separated by corresponding intervals, may have the initiating anchor (e.g., anchor 101(1)) again transmitting a set of signals 310 received as corresponding sets of signals 311 at a set of responding anchors (e.g., anchors 101(2), 101(4), and 101(5)), as seen, for example, in cycle 320(3). Importantly, in one or more subsequent cycles 320 of the round 301, one or more of the responding anchors may transmit a set of signals 310 received as corresponding sets of signals 311 at a set of other anchors including the initiating anchor. For example, as shown in illustration 300, in the sixth cycle 320(6), the fourth responding anchor (e.g., anchor 101(5)) transmits set of signals 310(6)(5), which is received as received sets of signals 311(6)(1) and 311(6)(2) by, respectively, the initiating anchor (e.g., anchor 101(1)) and the first responding anchor (e.g., anchor 101(2)). In some implementations, the first and/or last transmitted sets of signals (e.g., T1 and T9) may be synchronization frames (e.g., an SP3 type PPDU frame), while the intermediate transmitted sets of signals (e.g., T2-T8) may be data frames (e.g., SP0 type PPDU frames).

FIG. 4 shows example graphs illustrating aspects of corresponding CIR profiles. For example, graph 401 may correspond to a baseline CIR profile generated by a first round 301, while graph 402 may correspond to a first current CIR profile generated by a subsequent round 301. As can be seen, the highest peak in the CIR profile has shifted from zone 410 in graph 401 to zone 411 in graph 402, which corresponds to a change in the transmission environment of the communicating anchors. The controller 102 may be able to analyze the CIR profiles to determine that the environmental change has likely been caused by the presence of person in the transmission environment, who may be referred to as a candidate person. It should be noted that the analyzed differences are not limited to shifts in peaks in the CIR profile, which are used here only as an example.

Returning to UWB system 100 of FIG. 1, following a procedure as described above including comparing successive CIR profiles to determine the presence of a candidate person, further steps may be undertaken to verify whether the candidate person is indeed a person. The controller 102 can analyze the CIR profile data (e.g., as represented by the graphs 401 and 402 of FIG. 4) to determine a location for the candidate person. The controller 102 can then trigger a new, focused, communication round among a set of the anchors 101 to focus on the determined location and analyze the resultant CIR information to extract vital-signs information, if present, to determine whether a person is indeed present in the determined candidate-person location.

The received sets of signals may also be differently processed—by, for example, modifying the operating parameters of the receivers—to focus on the target location. For example, for vital-signs analysis, time-aperture zoom-in may be used to focus on a time window including portions of the received signal corresponding to the target location. UWB receivers are disclosed herein that provide a time-aperture zoom-in feature well suited for vital sign detection even in noisy environments.

Disclosed herein are systems, methods, and circuitries for UWB receivers that provide improved sensing of UWB signals to enable detection of vital signs or other minute movements of objects even in noisy environments.

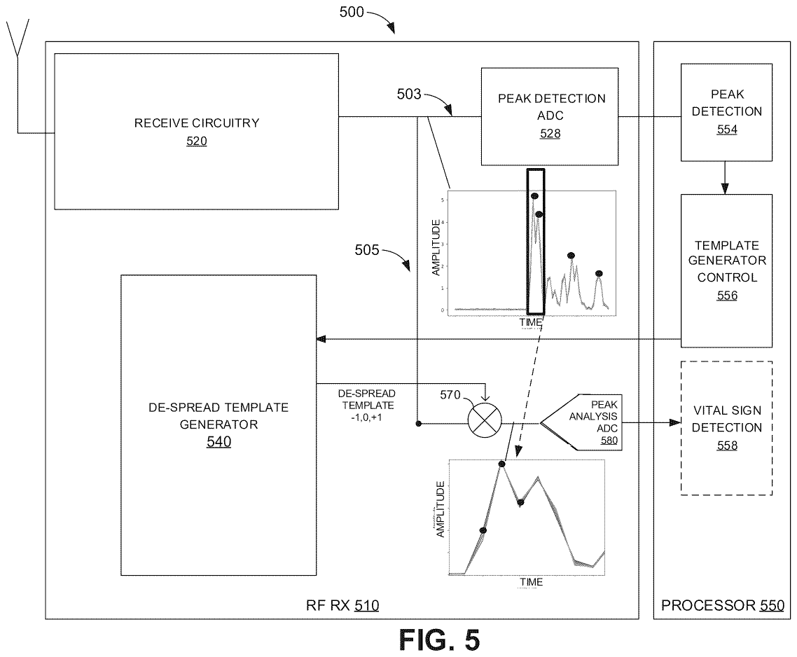

FIG. 5 illustrates an example UWB receiver 500 that includes a processor 550 and a radio frequency (RF) receiver 510 having a radio frequency (RF) processing path 503 and a de-spreading path 505. The RF receiver 510 includes receive circuitry 520 that performs initial processing, such as amplification and filtering of signals received by an antenna, to generate a received UWB signal. The received UWB signal may be, for example, a UWB signal transmitted by an anchor 101 that includes the receiver (e.g., in monostatic sensing) or by another anchor (e.g., bi-static sensing). As discussed above, the UWB signal encodes timing information for the transmitted signal and may also encode a code or sequence of bits that uniquely identify the transmitter.

The RF processing path includes a first analog-to-digital converter (ADC) 528 that may be referred to as a peak detection ADC. The peak detection ADC 528 may be optimized for quickly detecting peaks in a portion of a UWB signal that corresponds to a CIR profile. In other words the peak detection ADC may be a high speed or flash ADC that can capture the entire CIR profile very quickly, with sufficient resolution for detecting peaks indicating objects. An example CIR profile is illustrated in FIG. 5 as the input to the peak detection ADC 528. The time duration of the CIR profile may be, for example, around 80 nanoseconds. It can be seen that two significant peaks are present in the CIR profile as indicated by the bold outline around the first two peaks of the CIR profile.

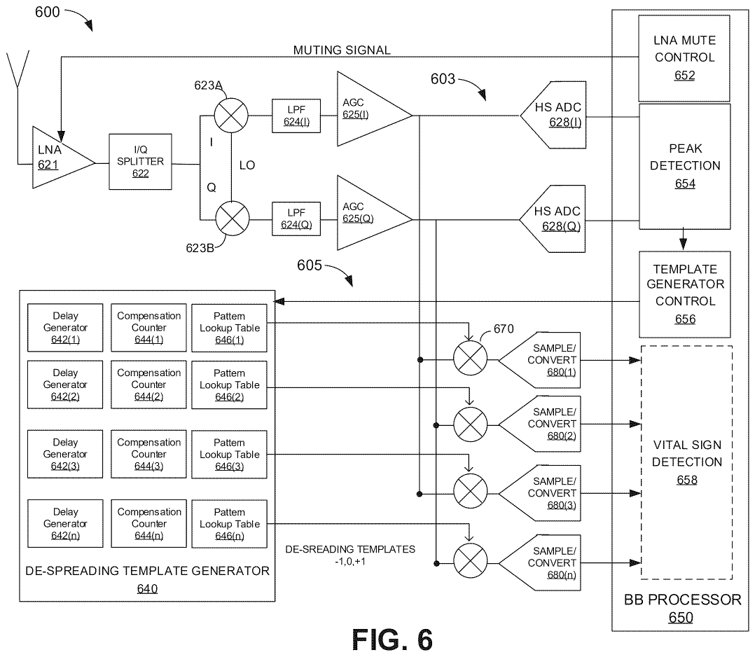

The processor 550 includes peak detection circuitry 554 that analyzes digital profile data (e.g., the digital version of the CIR profile) output by the peak detection ADC 528. The peak detection circuitry 554 identifies at least one time aperture in the CIR profile that may correspond to a human target and be useful in detecting vital signs. For example, the peak detection circuitry 554 may determine that the time aperture covered by the bold outline may correspond to a human target. The processor 550 includes template generator control circuitry 556 that generates a de-spreading template for the identified time aperture. As will be seen in FIG. 6, multiple time apertures may be identified for parallel processing by the de-spreading path.

The RF receiver 510 includes a de-spreading template generator 540 that is controlled by the template generator control circuitry 556. The de-spreading template generator 540 generates a de-spreading template, which is an analog signal corresponding to a sequence of values in the set {−1, 0, +1}. A time duration for each value is equal to the duration of a UWB signal chip (see, e.g., FIG. 2). The de-spreading template is provided to de-spreading circuitry 570. The de-spreading circuitry 570 multiplies the received UWB signal by the de-spreading template to generate a time aperture signal that is provided to a second ADC, also called a peak analysis ADC 580.

The de-spreading template includes 0 values in locations corresponding to time periods in the CIR profile that are outside the time aperture. For example, the de-spreading template may have an initial sequence of 0 values that have a time duration (when multiplied by the chip duration) equal to a number n nanoseconds and final sequence of 0 values that have a time duration equal to m nanoseconds, where the time aperture begins n nanoseconds after a beginning of the sample period and ends m seconds before the end of the sample period. When the de-spreading circuitry 570 multiplies the received UWB signal by the de-spreading template, the resulting signal will have a value of 0 except for within the range of the time aperture, as shown in FIG. 5 at the input to peak analysis ADC 580.

The de-spreading template also includes, within the time aperture a sequence of −1 and +1 values corresponding to the ranging signal transmitted by the particular transmitter. It is noted that the transmitter of the UWB signal may be the same device that includes the UWB receiver 500 or another device. When the transmitter of the UWB signal is a different device, the receiver 500 will be configured with information regarding the transmitted UWB signal (e.g., a selected sequence of −1 and +1 values) transmitted by other authorized devices so that the receiver 500 may distinguish between signals from the different devices.

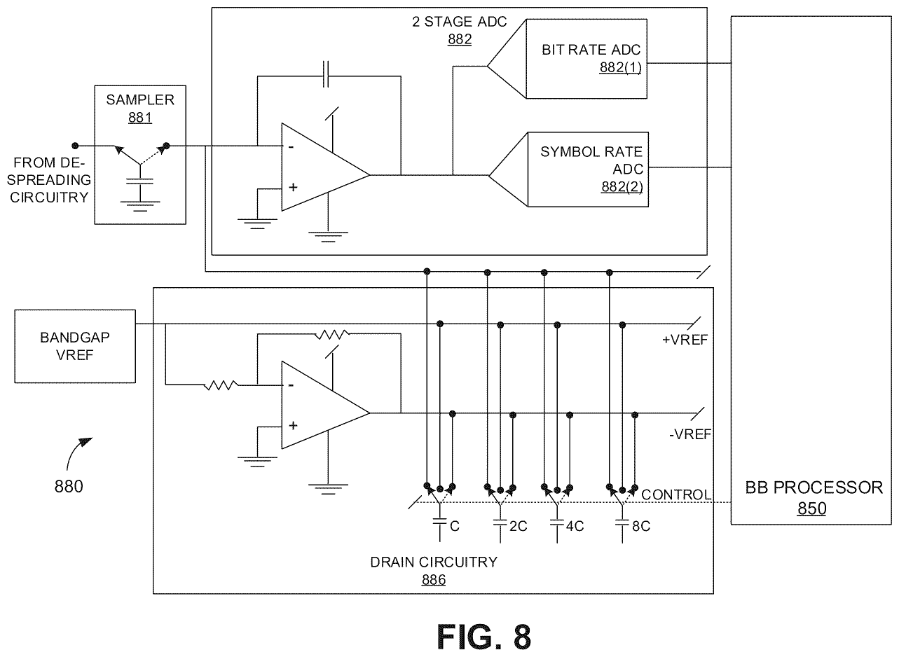

The de-spread signal is provided to the peak analysis ADC 580. One example architecture for the peak analysis ADC is illustrated in FIG. 8. The peak analysis ADC 580 may be an integrating ADC that is lower speed (as compared to peak detection (ADC 528) but with a higher resolution of both amplitude and phase. The de-spreading operation performed by the de-spreading circuitry 570 greatly reduces the quantity of data that needs to be processed by the peak analysis ADC 580, which compensates for the lower speed of the peak analysis ADC 580. The de-spreading operation may also rectify the de-spread signal to convert −1 values to +1 values or vice versa so that the de-spread signal may be accumulated by the peak analysis ADC 580. The high resolution digital data corresponding to the peaks occurring with the time aperture may be provided to vital sign detection circuitry 558. The vital detection circuitry may be embodied in the processor 550 or off chip in specialized processing circuitry.

In some examples, once the de-spreading template has been generated based on the detected peak(s) in the received UWB signal, the peak detection ADC 528 may be powered down and subsequent processing of the signal may be performed by the de-spreading path 505 only. The peak detection ADC 528 may be powered back on periodically on in response to some trigger condition when detection of peaks in the overall CIR is desired.

In the illustrated example, the peak detection ADC 528 and the peak analysis ADC are different types of ADCs, with the peak detection ADC 528 being a high-speed low resolution ADC and the peak analysis ADC 580 being a low-speed high resolution ADC. It is noted that in other examples, the peak detection ADC 528 may be a low-speed high resolution integrating type ADC. In this case the peak detection ADC may be operated in a sampling mode to scan across the entire CIR window (e.g., 80 nanoseconds). De-spreading templates may be generated to define time apertures corresponding to peaks in the output signal of the peak detection ADC 528 and the de-spread signals may be processed by the peak analysis ADC 580 in the same manner just described.

FIG. 6 illustrates an example UWB receiver 600 that includes a processor 650 and an RF processing path 603 and a de-spreading path 605. A received UWB signal is processed by a low noise amplifier (LNA) 621 and divided into in-phase (I) and quadrature (Q) signal components by I/Q splitter circuitry 622. The LNA 621 may be a muting LNA that includes circuitry that selectively diverts the received UWB signal from the LNA to mute the UWB signal so that the LNA does not receive the UWB signal. For example, the LNA 621 may include a bypass shorting path that is connected by way of a switch to ground.

The I and Q component signals are separately down-converted by downconverters 623A, 623B and amplified by automatic gain control (AGC) amplifiers 625(I), 625(Q). By maintaining separate processing paths for the I and Q component signals, phase information for the received UWB signal is preserved and may be used to carry additional information (e.g., an identity of a transmitter), for suppression of interference, and so on.

The I component signal is provided to a high speed ADC 628(I) and the Q component signal is provided to a high speed ADC 628(Q). The high speed ADCs 628 function as peak detection ADCs as described with reference to FIG. 5. The I component signal and the Q component signal are provided to selected sample/convert stages 680(1)-680(n). The sample/convert stages 680 function as peak analysis ADCs as described with reference to FIG. 5.

To enhance the interference suppression capabilities of the UWB receiver 600, an LNA muting feature may be provided. The processor 650, which has information about the timing of transmitted UWB signals by the device that includes the receiver 600, provides a muting signal to the LNA 621. FIG. 7 is timing diagram that illustrates an example relative timing as between the LNA muting signal 720, a transmit (TX) pulse 740 transmitted by the device that includes the receiver 600, and an example receive (RX) pulse 760. It can be seen that the LNA muting signal coincides with the TX pulse 740 so that the LNA (e.g., 621 of FIG. 6) does not receive UWB signals during the TX pulse 740. The LNA muting signal 720 may extend beyond the duration of the TX pulse based on the timing of the expected RX pulse to provide additional interference suppression and power saving. The timing of the expected RX pulse 760 (and the corresponding muting signal 720) may be adjusted based on the position of detected peaks in the received UWB signal. For example, once the peaks have been detected, the LNA muting signal may be extended to include portions of the CIR window that are not included in the time aperture around the detected peaks.

The de-spreading path 605 includes a number n of sample/convert stages 680. Each sample/convert stage is coupled to an associated de-spreading circuitry 670 that receives either an I signal component or a Q signal component of the received UWB signal. In some examples, the connections between the RF processing path and the de-spreading path are adjustable so that the particular signal component connected to any given de-spreading circuitry 670 may be switched as desired. In the illustrated example, n=4 thus there are four sample/convert stages 680.

As discussed above, the de-spreading template provided to each sample/convert state 680 defines a particular time aperture and transmit signal to be correlated and processed by the sample/convert stage. In this manner, different sample/convert stages may be used to process different time apertures in parallel to analyze several different potential target objects simultaneously.

In FIG. 6, the I signal component is provided to the first and third sample/convert stages 680(1) and 680(3) while the Q signal component is provided to the second and fourth sample/convert stages 680(2) and 680(n). In this manner, when an I signal component and a Q signal component are de-spread based on the same de-spreading template (e.g., focusing on the same time aperture), phase information may be preserved in the received UWB signal which may allow for very fine phase measurements giving sub millimeter resolution in object or vital sign detection depending on the signal to noise ratio (SNR) and the channel frequency. In other examples, the sample/convert stages 680 may receive different received UWB signal components.

The example de-spreading template generator 640 includes, for each sample/convert stage 680, delay generator 642, compensation counter 644, and pattern lookup table 646. Each of these components is controlled by the processor 650 based on detected peaks in the received UWB signal as well as information about the transmit signal known to the processor 650. The processor 650 controls the delay generator 642 to insert leading and following 0s to cancel out received UWB signal outside of the time aperture surrounding a detected peak (or other area of interest) in the received UWB signal. The processor 650 controls the pattern lookup table 646 to select a pattern of −1 and +1 values to include in the de-spreading template within the time aperture. The pattern is selected based on the modulation pattern (e.g., the values of the individual chips in FIG. 2) in use by the transmitter of the received UWB signal. The transmitter may be the device that includes the receiver 600 or a different transmitter (e.g., another anchor device) that utilizes a modulation pattern known to the receiver 600. Thus, different de-spreading templates may be used to isolate UWB signals received from different transmitters as well as during different time apertures.

The processor controls a compensation counter 644 that may be used when bi-static or multi-static sensing is used (e.g., when the transmitter is not the device that includes the receiver 600). The compensation counter 644 controls the duration of each pulse (e.g., the 0, −1 or +1 values) in the template. This function compensates for known differences in timing circuitry as between the transmitter of the received UWB signal and the receiver 600. If the frequency of the transmitter's oscillator is higher than the frequency of the receiver's oscillator, then the compensation counter may shrink the duration of the pulses in the template and vice versa.

FIG. 8 illustrates an example sample/convert stage 880. The sample/covert stage 880 includes a sampler 881 that samples, at high rate (e.g., 1 giga samples/second), the de-spread signal generated by a de-spreading circuitry. The samples are provided to a two stage accumulating ADCs 882 that includes a bit rate ADC 882(1) and a symbol rate ADC 882(2). The bit rate ADC 882(1) is a lower speed higher resolution accumulating ADC as compared to the symbol rate ADC 882(2). For example the ADC 882(1) may operate at 6.8 mega samples per second (e.g., which aligns the operation with the frequency of Zigbee radio) and have 6-12 bit resolution while the ADC 882(2) may operate at 62.4 mega samples per second (which aligns with the symbol rate of an HRP UWB signal) and have a 1-4 bit resolution.

The processor 850 controls drain circuitry 886 which is coupled to the 2 stage ADC 882 to selectively drain charge from the ADC 886 when either ADC 882(1) or 882(2) is approaching saturation. To this end, the processor 850 controls switches that selectively couple the ADC 882 to a capacitor stage that drains off a selected amount of charge. The processor 850 records the amount of charge being drained and adds this amount to the amount of accumulated charge in the ADCs 882(1) and 882(2) at the end of the time aperture.

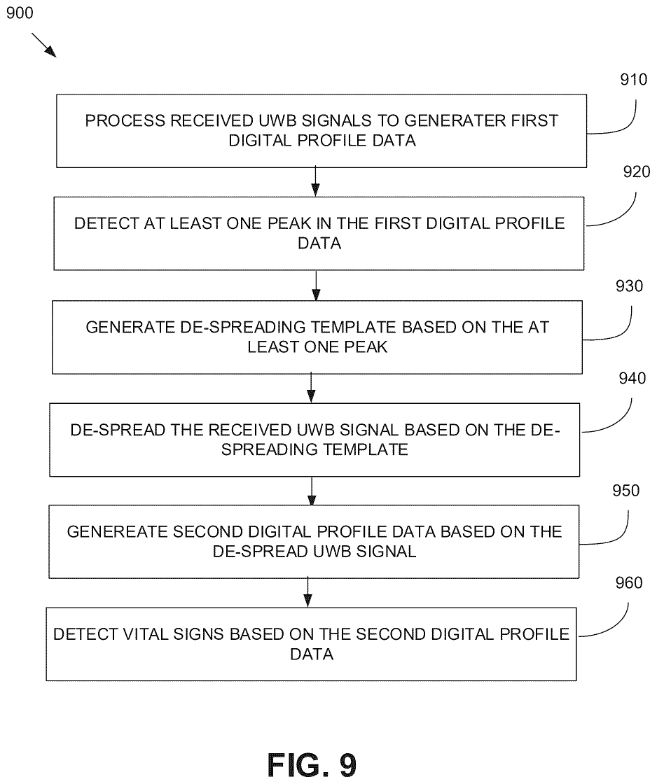

FIG. 9 is a flow diagram outlining an example method 900 for detecting vital signs based on received UWB signals. The method may be performed, for example, by UWB receiver 500 of FIG. 5 or 600 of FIG. 6. The method includes, at 910, processing received UWB signals to generate first digital profile data. In some examples, the method includes separately processing an in-phase component of the received UWB signal and a quadrature component of the received UWB signal to generate the first digital profile data. At 920, at least one peak is detected in the first digital profile data.

A de-spreading template is generated based on the at least one peak at 930. In some examples, the de-spreading template comprises a sequence of values from the set of {−1,0,+1} and at 930, the method includes inserting into the de-spreading template a number of 0 values that correspond to a delay between a beginning of a sampled received UWB signal and a beginning of a time aperture, wherein the time aperture is selected based on the at least one peak; and inserting a pattern of −1 values and +1 values corresponding to a pattern encoded in the received UWB signal. In some examples, at 930, the method also includes adjusting a time duration associated with each value in the sequence of values based on a timing difference between the UWB receiver and a transmitter of the UWB signal.

The method includes, at 940, de-spreading the received UWB signal based on the de-spreading template. At 950, second digital profile data is generated based on the de-spread received UWB signal and at 960 the method includes detecting vital signs based on the second digital profile data.

In some examples, the method 900 includes generating a muting control signal that mutes a muting low noise amplifier (LNA) based on a timing of a transmit signal.

It can be seen from the foregoing description that de-spreading a received UWB signal using a de-spreading template that is generated based on detected peaks in the UWB signal facilitates detection of vital signs.

Above are several flow diagrams outlining example methods. In this description and the appended claims, use of the term “determine” with reference to some entity (e.g., parameter, variable, and so on) in describing a method step or function is to be construed broadly. For example, “determine” is to be construed to encompass, for example, receiving and parsing a communication that encodes the entity or a value of an entity. “Determine” should be construed to encompass accessing and reading memory (e.g., lookup table, register, device memory, remote memory, and so on) that stores the entity or value for the entity. “Determine” should be construed to encompass computing or deriving the entity or value of the entity based on other quantities or entities. “Determine” should be construed to encompass any manner of deducing or identifying an entity or value of the entity.

As used herein, the term identify when used with reference to some entity or value of an entity is to be construed broadly as encompassing any manner of determining the entity or value of the entity. For example, the term identify is to be construed to encompass, for example, receiving and parsing a communication that encodes the entity or a value of the entity. The term identify should be construed to encompass accessing and reading memory (e.g., device queue, lookup table, register, device memory, remote memory, and so on) that stores the entity or value for the entity.

As used herein, the term indicate when used with reference to some entity (e.g., parameter or setting) or value of an entity is to be construed broadly as encompassing any manner of communicating the entity or value of the entity either explicitly or implicitly. For example, bits within a transmitted message may be used to explicitly encode an indicated value or may encode an index or other indicator that is mapped to the indicated value by prior configuration. The absence of a field within a message may implicitly indicate a value of an entity based on prior configuration.

As used herein, the term provide when used with reference to information or data or a signal encoding data is to be construed broadly as encompassing any manner of communicating the information, data, or signal encoding data either explicitly or implicitly. “Provide” should be construed to encompass transmitting a message that indicates the information or data, storing the information or data in memory accessible to the recipient of the providing, controlling electrical signals on conductors in a circuit to encode the information or data, and so on.

As used herein, the term obtain when used with reference to information or data or a signal encoding data is to be construed broadly as encompassing any manner of receiving the information, data, or signal encoding data either explicitly or implicitly. “Obtain” should be construed to encompass receiving a message that indicates the information or data, reading the information or data from memory, performing computations or processing on other data to obtain the information or data, detecting electrical signals on conductors in a circuit detect the information or data, and so on.

While the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, circuitries, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention.

Examples can include subject matter such as a method, means for performing acts or blocks of the method, at least one machine-readable medium including instructions that, when performed by a machine cause the machine to provide safety management on a per-application group basis according to embodiments and examples described herein.

### EXAMPLES

Example 1 is an ultra-wideband (UWB) receiver, including a processor, a first processing path and a second processing path for processing received UWB signals. The first processing path includes a first analog-to-digital converter (ADC) that generates first digital profile data. The second processing path includes a de-spreading circuitry configured to de-spread the received UWB signal based on a de-spreading template and a second ADC that generates second digital profile data based on the de-spread received UWB signal. The processor is configured to detect at least one peak in the first digital profile data and generate the de-spreading template based on the at least one peak.

Example 2 includes the subject matter of example 1, including or omitting optional elements, wherein the first ADC or the second ADC include a pair of ADCs that separately process an in-phase component of the received UWB signal and a quadrature component of the received UWB signal.

Example 3 includes the subject matter of example 1, including or omitting optional elements, wherein the processor is configured to generate the de-spreading template by generating a sequence of values from the set of {−1,0,+1} by inserting into the de-spreading template a number of 0 values that correspond to a delay between a beginning of a sampled received UWB signal and a beginning of a time aperture, wherein the time aperture is selected based on the at least one peak; and inserting a pattern of −1 values and +1 values corresponding to a pattern encoded in the received UWB signal.

Example 4 includes the subject matter of example 3, including or omitting optional elements, wherein the processor is further configured to adjust a time duration associated with each value in the sequence of values based on a timing difference between the UWB receiver and a transmitter of the UWB signal.

Example 5 includes the subject matter of example 1, including or omitting optional elements, wherein the second ADC includes a high speed integrating ADC; a lower speed integrating ADC; drain circuitry configured to, responsive to control signals from the processor, drain charge from the received UWB signal. The processor is configured to, in response to the high speed integrating ADC or the lower speed integrating ADC nearing saturation, control the drain circuitry to drain charge from the received UWB signal and adjust the second digital profile data based on an amount of charge that is drained by the drain circuitry.

Example 6 includes the subject matter of example 5, including or omitting optional elements, wherein a sampling speed of the high speed integrating ADC corresponds to a symbol rate of the received UWB signal and a sampling speed of the low speed integrating ADC corresponds to a bit rate of the received UWB signal.

Example 7 includes the subject matter of example 1, including or omitting optional elements, wherein the first ADC and the second ADC include a same type of ADC.

Example 8 includes the subject matter of example 1, including or omitting optional elements, including a muting low noise amplifier (LNA) that amplifies a signal received by an antenna of the UWB receiver to generate the received UWB signal, wherein the processor is configured to generate a muting control signal that mutes the LNA based on a timing of a transmit signal of the UWB receiver.

Example 9 is a method, including processing received UWB signals to generate first digital profile data; detecting at least one peak in the first digital profile data; generating a de-spreading template based on the at least one peak; de-spreading the received UWB signal based on the de-spreading template; generating second digital profile data based on the de-spread received UWB signal; and detecting vital signs based on the second digital profile data.

Example 10 includes the subject matter of example 9, including or omitting optional elements, including separately processing an in-phase component of the received UWB signal and a quadrature component of the received UWB signal to generate the first digital profile data.

Example 11 includes the subject matter of example 9, including or omitting optional elements, including generating the de-spreading template by generating a sequence of values from the set of {−1,0,+1} by inserting into the de-spreading template a number of 0 values that correspond to a delay between a beginning of a sampled received UWB signal and a beginning of a time aperture, wherein the time aperture is selected based on the at least one peak; and inserting a pattern of −1 values and +1 values corresponding to a pattern encoded in the received UWB signal.

Example 12 includes the subject matter of example 11, including or omitting optional elements, including adjusting a time duration associated with each value in the sequence of values based on a timing difference between the UWB receiver and a transmitter of the UWB signal.

Example 13 includes the subject matter of example 9, including or omitting optional elements, including generating a muting control signal that mutes a muting low noise amplifier (LNA) based on a timing of a transmit signal.

Example 14 is a vital sign detection system, including peak detection circuitry configured to detect at least one peak in first digital profile data that is based on a received ultra-wideband (UWB) signal; a de-spreading template generator configured to generate a de-spreading template based on the at least one peak; a de-spreading circuitry configured to de-spread the received UWB signal based on the de-spreading template; an ADC that generates second digital profile data based on the de-spread received UWB signal; and a processor configured to detect vital signs based on the second digital profile data.

Example 15 includes the subject matter of example 14, including or omitting optional elements, further including template generator control circuitry configured to insert a pattern of −1 values and +1 values corresponding to a pattern encoded in the received UWB signal into the de-spreading template; and a delay generator configured to insert into the de-spreading template a number of 0 values that correspond to a delay between a beginning of a sampled received UWB signal and a beginning of a time aperture, wherein the time aperture is selected based on the at least one peak, wherein the de-spreading template includes a sequence of values from the set of {−1,0,+1}.

Example 16 includes the subject matter of example 15, including or omitting optional elements, further including a compensation counter configured to adjust a time duration associated with each value in the sequence of values based on a timing difference between the UWB receiver and a transmitter of the UWB signal.

Example 17 includes the subject matter of example 14, including or omitting optional elements, including an ADC that includes a high speed integrating ADC; a lower speed integrating ADC; and drain circuitry configured to, responsive to control signals from the processor, drain charge from the received UWB signal, wherein the processor is configured to, in response to the high speed integrating ADC or the lower speed integrating ADC nearing saturation, control the drain circuitry to drain charge from the received UWB signal and adjust the second digital profile data based on an amount of charge that is drained by the drain circuitry.

Example 18 includes the subject matter of example 17, including or omitting optional elements, wherein a sampling speed of the high speed integrating ADC corresponds to a symbol rate of the received UWB signal

Example 19 includes the subject matter of example 17, including or omitting optional elements, wherein a sampling speed of the low speed integrating ADC corresponds to a bit rate of the received UWB signal.

Example 20 includes the subject matter of example 14, including or omitting optional elements, including a muting low noise amplifier (LNA) that amplifies a signal received by an antenna of a UWB receiver to generate the received UWB signal, wherein the processor is configured to generate a muting control signal that mutes the LNA based on a timing of a transmit signal of the UWB receiver.

Various illustrative logics, logical blocks, modules, circuitries, and circuits described in connection with aspects disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform functions described herein. A general-purpose processor can be a microprocessor, but, in the alternative, processor can be any conventional processor, controller, microcontroller, or state machine.

In the present disclosure like reference numerals are used to refer to like elements throughout, and wherein the illustrated structures and devices are not necessarily drawn to scale. As utilized herein, terms “module”, “component,” “system,” “circuit,” “circuitry,” “element,” “slice,” and the like are intended to refer to a computer-related entity, hardware, software (e.g., in execution), and/or firmware. For example, circuitry or a similar term can be a processor, a process running on a processor, a controller, an object, an executable program, a storage device, and/or a computer with a processing device. By way of illustration, an application running on a server and the server can also be circuitry. One or more circuitries can reside within a process, and circuitry can be localized on one computer and/or distributed between two or more computers. A set of elements or a set of other circuitry can be described herein, in which the term “set” can be interpreted as “one or more.”

As another example, circuitry or similar term can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, circuitry can be an apparatus that provides specific functionality through electronic components without mechanical parts; the electronic components can include field gates, logical components, hardware encoded logic, register transfer logic, one or more processors therein to execute software and/or firmware that confer(s), at least in part, the functionality of the electronic components.

Use of the word exemplary is intended to present concepts in a concrete fashion. The terminology used herein is for the purpose of describing particular examples only and is not intended to be limiting of examples. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. As used herein the term “or” includes the option of all elements related by the word or. For example A or B is to be construed as include only A, only B, and both A and B. Further the phrase “one or more of” followed by A, B, or C is to be construed as including A, B, C, AB, AC, BC, and ABC.

What is claimed is:

1. An ultra-wideband (UWB) receiver, comprising:
a first processing path for processing received UWB signals, the first processing path comprising a first analog-to-digital converter (ADC) that generates first digital profile data;
a second processing path for processing the received UWB signal, the second processing path comprising
a de-spreading circuitry configured to de-spread the received UWB signal based on a de-spreading template; and
a second ADC that generates second digital profile data based on the de-spread received UWB signal; and
a processor configured to
detect at least one peak in the first digital profile data; and
generate the de-spreading template based on the at least one peak.

2. The UWB receiver of claim 1 wherein the first ADC or the second ADC comprise a pair of ADCs that separately process an in-phase component of the received UWB signal and a quadrature component of the received UWB signal.

3. The UWB receiver of claim 1, wherein the processor is configured to generate the de-spreading template by generating a sequence of values from the set of {−1,0,+1} by
inserting into the de-spreading template a number of 0 values that correspond to a delay between a beginning of a sampled received UWB signal and a beginning of a time aperture, wherein the time aperture is selected based on the at least one peak; and
inserting a pattern of −1 values and +1 values corresponding to a pattern encoded in the received UWB signal.

4. The UWB receiver of claim 3, wherein the processor is further configured to adjust a time duration associated with each value in the sequence of values based on a timing difference between the UWB receiver and a transmitter of the UWB signal.

5. The UWB receiver of claim 1, wherein the second ADC comprises
a high speed integrating ADC;
a lower speed integrating ADC; and
drain circuitry configured to, responsive to control signals from the processor, drain charge from the received UWB signal,
wherein the processor is configured to, in response to the high speed integrating ADC or the lower speed integrating ADC nearing saturation, control the drain circuitry to drain charge from the received UWB signal and adjust the second digital profile data based on an amount of charge that is drained by the drain circuitry.

6. The UWB receiver of claim 5, wherein
a sampling speed of the high speed integrating ADC corresponds to a symbol rate of the received UWB signal; and
a sampling speed of the low speed integrating ADC corresponds to a bit rate of the received UWB signal.

7. The UWB receiver of claim 1, wherein the first ADC and the second ADC comprise a same type of ADC.

8. The UWB receiver of claim 1, comprising a muting low noise amplifier (LNA) that amplifies a signal received by an antenna of the UWB receiver to generate the received UWB signal, wherein the processor is configured to generate a muting control signal that mutes the LNA based on a timing of a transmit signal of the UWB receiver.

9. A method, comprising:
processing received UWB signals to generate first digital profile data;
detecting at least one peak in the first digital profile data;
generating a de-spreading template based on the at least one peak;
de-spreading the received UWB signal based on the de-spreading template;
generating second digital profile data based on the de-spread received UWB signal; and
detecting vital signs based on the second digital profile data.

10. The method of claim 9, comprising separately processing an in-phase component of the received UWB signal and a quadrature component of the received UWB signal to generate the first digital profile data.

11. The method of claim 9, comprising generating the de-spreading template by generating a sequence of values from the set of {−1,0,+1} by
inserting into the de-spreading template a number of 0 values that correspond to a delay between a beginning of a sampled received UWB signal and a beginning of a time aperture, wherein the time aperture is selected based on the at least one peak; and
inserting a pattern of −1 values and +1 values corresponding to a pattern encoded in the received UWB signal.

12. The method of claim 11, comprising adjusting a time duration associated with each value in the sequence of values based on a timing difference between the UWB receiver and a transmitter of the UWB signal.

13. The method of claim 9, comprising generating a muting control signal that mutes a muting low noise amplifier (LNA) based on a timing of a transmit signal.

14. A vital sign detection system, comprising:
peak detection circuitry configured to detect at least one peak in first digital profile data that is based on a received ultra-wideband (UWB) signal;
a de-spreading template generator configured to generate a de-spreading template based on the at least one peak;
a de-spreading circuitry configured to de-spread the received UWB signal based on the de-spreading template;
an ADC that generates second digital profile data based on the de-spread received UWB signal; and
a processor configured to detect vital signs based on the second digital profile data.

15. The vital sign detection system of claim 14, further comprising
template generator control circuitry configured to insert a pattern of −1 values and +1 values corresponding to a pattern encoded in the received UWB signal into the de-spreading template; and
a delay generator configured to insert into the de-spreading template a number of 0 values that correspond to a delay between a beginning of a sampled received UWB signal and a beginning of a time aperture, wherein the time aperture is selected based on the at least one peak,
wherein the de-spreading template comprises a sequence of values from the set of {−1,0,+1}.

16. The vital sign detection system of claim 15, further comprising a compensation counter configured to adjust a time duration associated with each value in the sequence of values based on a timing difference between the UWB receiver and a transmitter of the UWB signal.

17. The vital sign detection system of claim 14, comprising an ADC that includes
a high speed integrating ADC;
a lower speed integrating ADC; and
drain circuitry configured to, responsive to control signals from the processor, drain charge from the received UWB signal,
wherein the processor is configured to, in response to the high speed integrating ADC or the lower speed integrating ADC nearing saturation, control the drain circuitry to drain charge from the received UWB signal and adjust the second digital profile data based on an amount of charge that is drained by the drain circuitry.

18. The vital sign detection system of claim 17, wherein a sampling speed of the high speed integrating ADC corresponds to a symbol rate of the received UWB signal.

19. The vital sign detection system of claim 17, wherein a sampling speed of the low speed integrating ADC corresponds to a bit rate of the received UWB signal.

20. The vital sign detection system of claim 14, comprising a muting low noise amplifier (LNA) that amplifies a signal received by an antenna of a UWB receiver to generate the received UWB signal, wherein the processor is configured to generate a muting control signal that mutes the LNA based on a timing of a transmit signal of the UWB receiver.
